(19) United States
(12) Patent Application Publication
(10) Pub. No.: US 2026/0324907 A1
(43) Pub. Date: Oct. 22, 2026

(54) OIL DISPENSER

(71) Applicants: WEIAN GE, Jiangyan (CN); XIAOYU YE, Huangshan (CN)

(72) Inventors: WEIAN GE, Jiangyan (CN); XIAOYU YE, Huangshan (CN)

(21) Appl. No.: 19/695,289

(22) Filed: Jun. 2, 2026

(30) Foreign Application Priority Data
May 22, 2026 (CN) 202620731914.3

(51) Int. Cl. A47J 47/01

(52) U.S. Cl. CPC A47J 47/01

(57) ABSTRACT

An oil dispenser includes a lid and a bottle. The lid is provided with an actuator, an oil spraying member and an oil pouring spout. A cover plate for sealing the oil pouring spout is rotatably connected to the lid. An elastic element is arranged between the cover plate and the lid, and the cover plate keeps sealing the oil pouring spout under the action of the elastic element. A link is arranged between the actuator and the cover plate. In a first operation state, the actuator presses the oil spraying member to spray oil. In a second operation state, the actuator acts on the cover plate by means of the link to enable the cover plate to open the oil pouring spout. The present disclosure can achieve both an oil spraying function and an oil pouring function by means of one actuator.

### CROSS-REFERENCE TO RELATED APPLICATIONS

This application claims priority to Chinese Patent Application No. 202620731914.3, filed on May 22, 2026, which is hereby incorporated by reference in its entirety.

### TECHNICAL FIELD

The present disclosure belongs to the technical field of household daily necessities, and particularly relates to an oil dispenser.

### BACKGROUND

With the diversification of cooking styles, oil dispensers with both an oil spraying function and an oil pouring function have emerged on the market to improve the convenience of use. At present, a common design of the oil dispensers with both the oil spraying function and the oil pouring function is to integrate an oil spraying spout and an oil pouring spout into a lid. Such oil dispensers are typically operated by separate control: the oil pouring function is controlled by means of a cover plate that is manually rotated to open or close an oil pouring spout, and the cover plate is driven by an independent button or lever; while the oil spraying function is controlled by means of an independent press member, which drives a pump to press oil out via an oil spraying spout when pressed. Although this scheme achieves two functions, it is not convenient for users to operate different control components separately when spraying or pouring oil.

### SUMMARY

To overcome the defects in the prior art, the present disclosure provides an oil dispenser, which can achieve both an oil spraying function and an oil pouring function by means of one actuator.

The present disclosure is implemented by means of the following technical solution: An oil dispenser includes a lid and a bottle. The lid is provided with:
an actuator, rotatably connected to the lid, partially uncovered by the lid to be operated, and partially extending into the lid;
an oil spraying member, arranged below the actuator and used for spraying oil when pressed by the actuator;
an oil pouring spout, used for pouring oil and communicating an inside of the bottle with an outside;
a cover plate, rotatably connected to the lid and having a closed position for sealing the oil pouring spout;
an elastic element, arranged between the cover plate and the lid, and used for applying an elastic force to the cover plate to enable the cover plate to tend to the closed position; and
a link, arranged between the actuator and the cover plate.

The actuator has a first operation state and a second operation state. In the first operation state, the actuator acts on the oil spraying member to spray oil. In the second operation state, the actuator acts on the cover plate by means of the link to enable the cover plate to open the oil pouring spout.

According to the oil dispenser in the present disclosure, by means of the rotatable actuator with the first operation state and the second operation state, oil spraying and lid opening for oil pouring are controlled by a single component. By adopting such a design, the operation logic is visual, and users may switch the functions quickly with a single hand, thus improving the convenience of use; in addition, the internal structure of the lid is simplified, and manufacturing costs are reduced.

The elastic element may be a torsion spring arranged at the position where the cover plate and the lid are rotatably connected.

In one embodiment of the present disclosure, the link includes a first abutting portion arranged on the cover plate and a second abutting portion arranged on the actuator;
when pressed, the actuator enters the first operation state to press the oil spraying member to implement oil spraying;
when lifted, the actuator enters the second operation state, and the second abutting portion pushes against the first abutting portion to enable the cover plate to overcome the elastic force of the elastic element to rotate, so as to open the oil pouring spout.

In this way, lifting and pressing are the easiest one-handed operations for users when the users hold the oil dispenser, and the users may easily operate the actuator with a single hand to spray oil or to open the lid to pour oil.

In one embodiment of the present disclosure, the elastic element includes an elastic portion, as well as a first connection portion and a second connection portion which are connected to the elastic portion, the fist connection portion is connected to the cover plate, and the second connection portion is connected to the lid;
when the actuator is lifted and drives the cover plate to open the oil pouring spout, the first connection portion and the second connection portion move close to each other, such that the elastic portion generates an elastic force for driving the first connection portion and the second connection portion to move away from each other.

In this way, after the actuator is released by users, the cover plate may automatically return to the original position under the action of the elastic force.

In one embodiment of the present disclosure, the elastic element is a torsion spring;
the elastic portion is a spiral portion of the torsion spring and is in a free suspended state;
the first connection portion and the second connection portion are two spring legs of the torsion spring, respectively;
the cover plate is provided with a first pin around which the first connection portion is disposed, and the lid is provided with a second pin around which the second connection portion is disposed.

The elastic portion of the elastic element is in the free suspended state, such that the elastic portion has a good degree of freedom, and when the first connection portion and the second connection move close to each other, the position of the elastic portion may be adaptively adjusted, thereby prolonging the service life of the elastic portion.

In one embodiment of the present disclosure, the first abutting portion and the second abutting portion are both toothed; and when the actuator is lifted, the first abutting portion and the second abutting portion are engaged with each other.

In this way, the first abutting portion and the second abutting portion may be engaged when abutting against each other, to better transmit torque.

In one embodiment of the present disclosure, a first rotating shaft is arranged at an end, located inside the lid, of the actuator, and the lid is provided with a shaft hole rotatably connected to the first rotating shaft.

In one embodiment of the present disclosure, the oil spraying member includes a pump, an oil spraying spout, a first dip tube connected between the pump and the bottle, and a second dip tube connected between the pump and the oil spraying spout;
a matching socket with an opening facing downward is formed in a lower end of the actuator, and at least an upper portion of the pump is received in the matching socket;
in a natural state, the actuator is supported on the pump by means of a wall of the matching socket.

In this way, the structure is more compact.

In one embodiment of the present disclosure, the actuator is configured to press the pump downward by means of the wall of the matching socket when pressed, so as to enable the pump to pump oil.

In one embodiment of the present disclosure, the lid includes a hood and a base, two vertical plates extending upward are arranged on the base, the cover plate is located between the vertical plates and provided with a second rotating shaft, and the vertical plates are provided with shaft holes rotatably connected to the second rotating shaft.

In one embodiment of the present disclosure, the second dip tube is located on an outer side of the vertical plates and extends in a circumferential direction of the base.

By adopting such an arrangement of the second dip tube, the structure is more compact.

In one embodiment of the present disclosure, a relief groove with an opening facing upward is formed in the actuator; and when the actuator is lifted and the cover plate opens the oil pouring spout, an end, away from the oil pouring spout, of the cover plate is located in the relief groove.

In this way, the structure is more compact, and the cover plate is prevented from interfering with the actuator when opened.

In one embodiment of the present disclosure, a limiting protrusion is arranged on the second rotating shaft of the cover plate; an inner wall of a top of the hood of the lid corresponds to the limiting protrusion; and when the cover plate is rotated to be opened, the limiting protrusion rotates together with the second rotating shaft and abuts against the inner wall of the top of the hood to limit a maximum opening angle of the cover plate.

In one embodiment of the present disclosure, an oil pouring passage is integrally formed in the base, an inlet end of the oil pouring passage communicates with the inside of the bottle, and the oil pouring spout is arranged at an outlet end of the oil pouring passage.

In one embodiment of the present disclosure, an end, extending into the lid, of the actuator is U-shaped, and an open side of the U-shaped end faces the oil pouring passage, such that a clearance for receiving the oil pouring passage is formed between the actuator and the base.

In one embodiment of the present disclosure, a plug is arranged on the cover plate, and with the rotation of the cover plate, the plug selectively seals the oil pouring spout.

In one embodiment of the present disclosure, the cover plate is provided with a first link block extending towards the actuator, and the first abutting portion is arranged at an end of the first link block; and the actuator is provided with a second link block extending towards the cover plate, and the second abutting portion is arranged at an end of the second link block.

In one embodiment of the present disclosure, a vent hole, extending through the base, is formed in a side, away from the oil pouring passage, of the base.

The vent hole may balance the air pressure in the bottle and the air pressure in the outside; and the vent hole is away from the oil pouring passage, such that oil is prevented from flowing into the vent hole when poured out of the bottle.

Compared with the prior art, the present disclosure has the following beneficial effects: the rotatable actuator is arranged and configured to drive the oil spraying member to spray oil when pressed and pushes against the cover plate by means of the link to open the oil pouring spout when lifted, such that oil spraying and lid opening for oil pouring are controlled by a single component. By adopting such a design, the operation logic is visual, and users may switch the functions quickly with a single hand, thus improving the convenience of use; in addition, the internal structure of the lid is simplified, and manufacturing costs are reduced.

### BRIEF DESCRIPTION OF DRAWINGS

FIG. 1 is a schematic overall structural diagram of an oil dispenser.

FIG. 2 is a schematic structural diagram of the oil dispenser in a case where an actuator is lifted.

FIG. 3 is a schematic structural diagram of FIG. 1 in a case where a hood is removed.

FIG. 4 is a schematic structural diagram of FIG. 3 in a case where the actuator is removed.

FIG. 5 is a sectional view of FIG. 1.

FIG. 6 is a schematic structural diagram of an elastic element and a cover plate.

FIG. 7 is a schematic structural diagram of FIG. 2 in a case where the hood is removed.

FIG. 8 is a sectional view of FIG. 2.

FIG. 9 is a sectional view of FIG. 2.

FIG. 10 is a top view of FIG. 1 in a case where the hood is removed.

FIG. 11 is a schematic structural diagram of an oil spraying member.

FIG. 12 is a schematic structural diagram of the bottom of a base.

Reference signs: 1, lid; 11, cover plate; 111, opening; 112, first pin; 113, plug; 114, first link block; 12, base; 121, vent hole; 13, vertical plate; 131, second pin; 14, hood; 2, bottle; 3, handle; 4, actuator; 41, second link block; 42, U-shaped end; 43, relief groove; 44, matching socket; 5, oil spraying member; 51, oil spraying spout; 52, first dip tube; 53, pump; 54, second dip tube; 6, elastic element; 61, first connection portion; 62, elastic portion; 63, second connection portion; 7, oil pouring spout; 71, oil pouring passage; 81, first rotating shaft; 82, second rotating shaft; 821, limiting protrusion; 91, first abutting portion; 92, second abutting portion.

### DESCRIPTION OF EMBODIMENTS

The present disclosure is further described below in conjunction with accompanying drawings and specific embodiments.

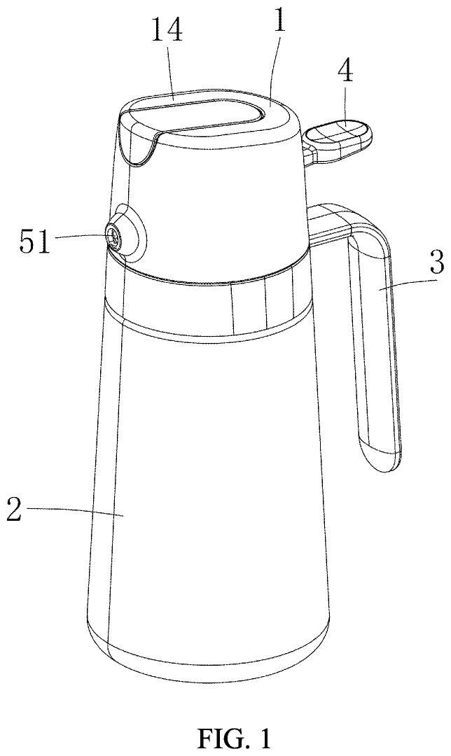

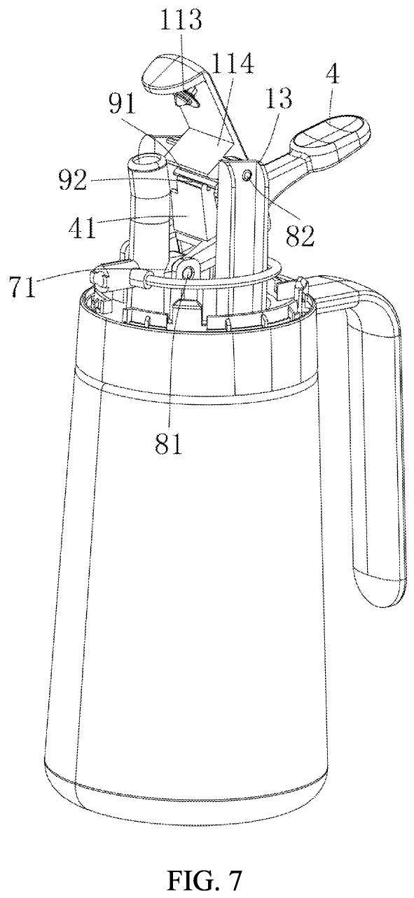

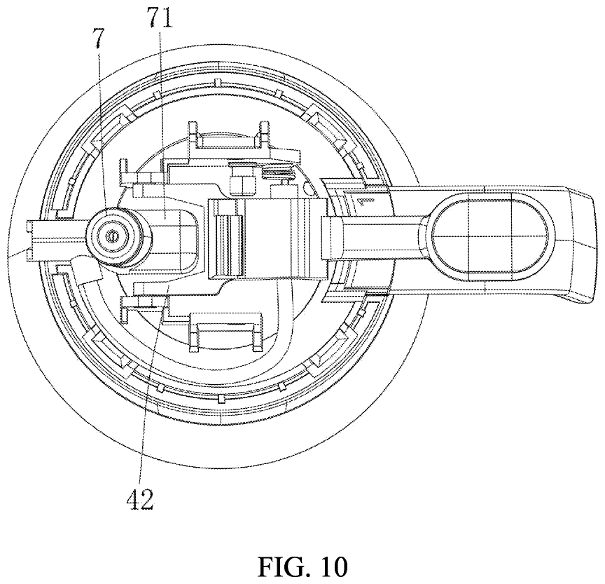

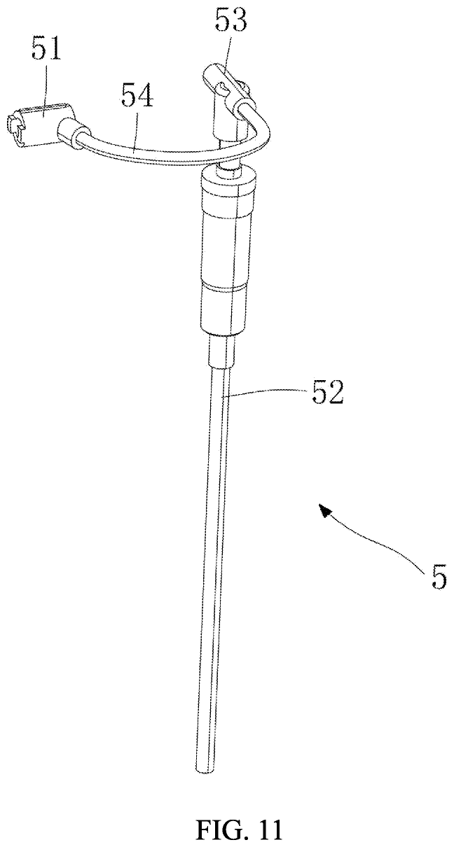

As shown in FIGS. 1-11, an embodiment of the present disclosure provide an oil dispenser. The oil dispenser includes a lid 1 and a bottle 2. A handle 3 is fixed to the lid 1. The bottle 2 is used for containing edible oil, and an opening is formed in an upper portion of the bottle 2. The lid 1 detachably covers the opening of the bottle 2, for example, the lid 1 may be fixed to the bottle 2 by threaded connection, snap-fit connection, or the like. In an implementation mode of this embodiment, the lid 2 is fixed to the bottle 2 by threaded connection. Both an oil spraying function and an oil pouring function are integrated in the lid 1 and are controlled by means of a same actuator 4. The actuator 4 is operated by users and has a first operation state as well as a second operation state, and the first operation state and the second operation state respectively correspond to the oil spraying function and the oil pouring function.

In an implementation mode, referring to FIGS. 1, 3, 5 and 10, the lid 1 typically includes a base 12 and a hood 14. Most functional components are mounted on the base 12, and the hood 14 covers the base 12 to form a housing of the lid 1. The hood 14 and the base 12 are fixed together by means of a snap-fit structure. The actuator 4 is rod-like or plate-like on the whole. An end, located inside the lid 1, of the actuator 4 is provided with a first rotating shaft 81, and the first rotating shaft 81 is rotatably connected to the lid 1 (to be specific, to the base 12). An end (referred to as an operating end), located outside the lid 1, of the actuator 4 is uncovered by the hood 14, so as to be pressed or lifted by users with fingers. In this embodiment, the end, extending into the lid 1, of the actuator 4 is U-shaped to form a U-shaped end 42, and the first rotating shaft 81 is arranged at the U-shaped end 42.

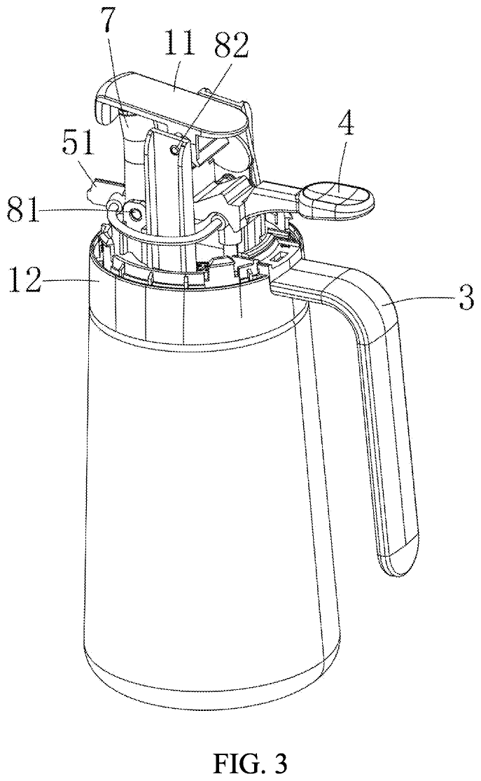

As shown in FIGS. 3, 5, 8 and 11, the oil spraying function is implemented mainly by means of an oil spraying member 5. The oil spraying member 5 includes a pump 53, an oil spraying spout 51, a first dip tube 52 and a second dip tube 54. The pump 53 is arranged below the actuator 4. One end of the first dip tube 52 is connected to an oil inlet of the pump 53, and the other end of the first dip tube 52 extends to the bottom of the bottle 2. One end of the second dip tube 54 is connected to an oil outlet of the pump 53, and the other end of the second dip tube 54 is connected to the oil spraying spout 51. A matching socket 44 with an opening facing downward is formed in a lower surface of the actuator 4. In a natural state (i.e., an unstressed state), an upper portion of the pump 52 is received in the matching socket 44, and the actuator 4 is supported on the pump 53 by means of a wall of the matching socket 44. When users press the operating end of the actuator 4, the actuator 4 rotates around the first rotating shaft 81 and pushes the pump 53 downward by means of the wall of the matching socket 44 to drive the pump 53 to operate, so as to suck oil from the bottle 2 via the first dip tube 52 and then press the oil out of the oil spraying spout 51 via the second dip tube 54 to achieve oil spraying. After the pressure is released, a return spring (not shown) in the pump 53 drives a piston of the pump 53 to return, and the actuator 4 returns to the original position accordingly.

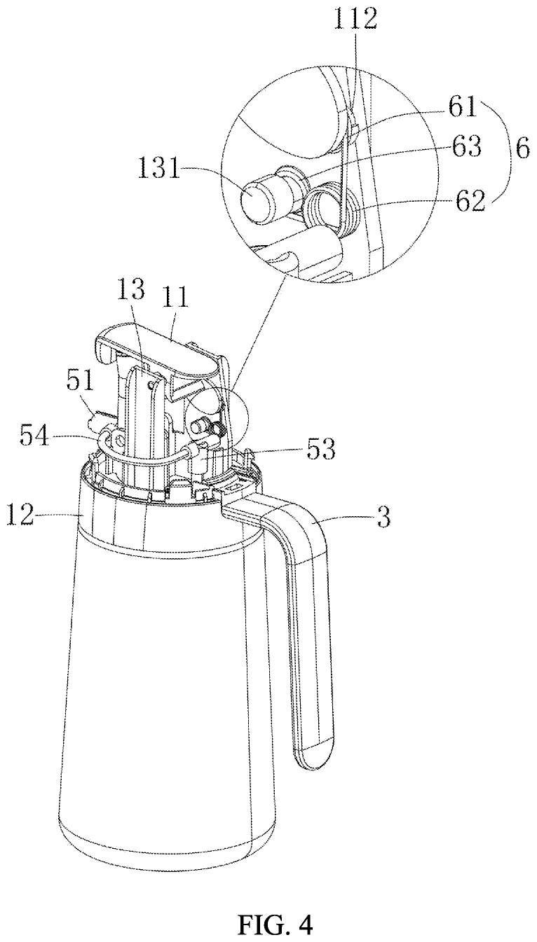

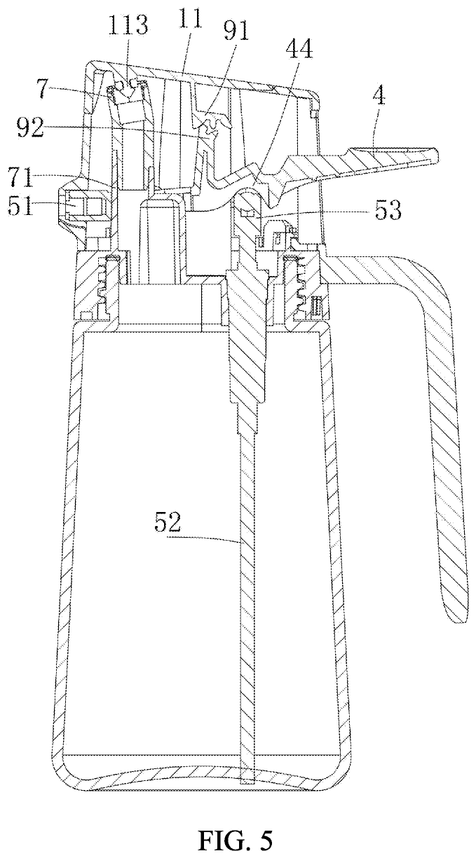

As shown in FIGS. 4, 6, 7 and 9, the oil pouring function is implemented mainly by means of an oil pouring spout 7, a cover plate 11 and an elastic element 6. An opening 111 is formed in the top of the hood 14, and the cover plate 11 is fitted to the opening 111. An oil pouring passage 71 is integrally formed in the base 12, an inlet end of the oil pouring passage 71 communicates with the inside of the bottle 2, and the oil pouring spout 7 is mounted at an outlet end of the oil pouring passage 71. An open side of the U-shaped end 42 of the actuator 4 faces the oil pouring passage 71, such that a clearance for receiving the oil pouring passage 71 is formed between the actuator 4 and the base 12. The cover plate 11 is rotatably connected to the base 12 by means of the second rotating shaft 2. In an implementation mode, two vertical plates 14 extending upward are arranged on the base 12, the cover plate 11 is located between the two vertical plates 13, and two sides of the cover plate 11 are rotatably connected to shaft holes in the vertical plates 13 by means of second rotating shaft 82. A plug 113 is arranged on the cover plate 11. When the cover plate 11 is located at a closed position (as shown in FIG. 5), the plug 113 is tightly fitted into the oil pouring spout 7 under the action of an elastic force of the elastic element 6 to seal the oil pouring spout 7. The elastic element 6 is a torsion spring, and includes a spiral elastic portion 62 as well as a first connection portion 61 and a second connection portion 63 which extend out from two ends of the elastic element 62. The elastic portion 62 is in a free suspended state. The first connection portion 61 is disposed around a first pin 112 on the cover plate 11, and the second connection portion 63 is disposed around a second pin 131 on one of the vertical plates 13 of the base 12. In a normal state, the elastic element 6 provides an elastic force for the cover plate 11 to enable the cover plate 11 to tend to the closed position (i.e., to enable the plug 113 to seal the oil pouring spout 7).

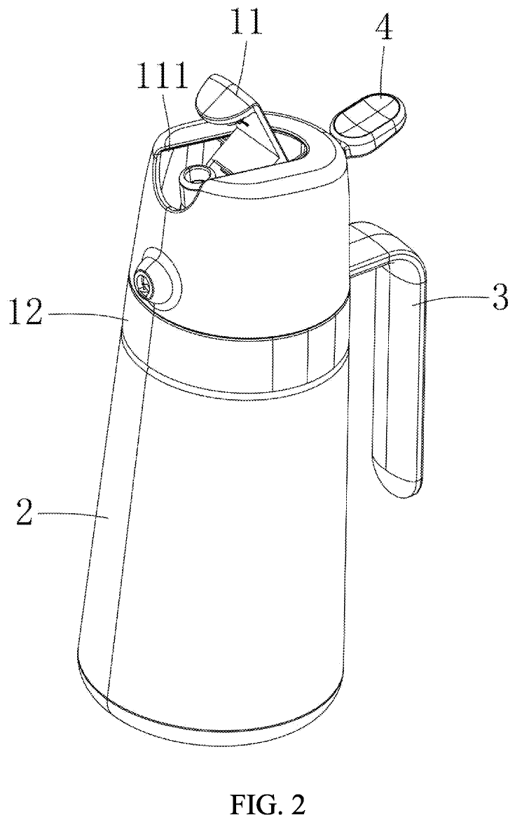

A link is arranged between the actuator 4 and the cover plate 11. In an implementation mode, the cover plate 11 is provided with a first link block 114 extending towards the actuator 4, and a first abutting portion 91 is arranged at an end of the cover plate 11. The actuator 4 is provided with a second link block 41 extending towards the cover plate 11, and a second abutting portion 92 is arranged at one end of the actuator 91. The first abutting portion 91 and the second abutting portion 92 may be designed into toothed structure engaged with each other. When users elevate the operating end of the actuator 4, the actuator 4 rotates reversely around the first rotating shaft 81, the second abutting portion 92 on the actuator 4 pushes against and is engaged with the first abutting portion 91 on the cover plate 11, such that the cover plate 11 overcomes the elastic force of the elastic element 6 to rotate around the second rotating shaft 82, so as to drive the plug 113 to move away from the oil pouring spout 7 to open the oil pouring passage 71, and at this moment, oil may be poured out of the bottle 2 via the oil pouring spout 7 (as shown in FIGS. 2, 7, 8 and 9).

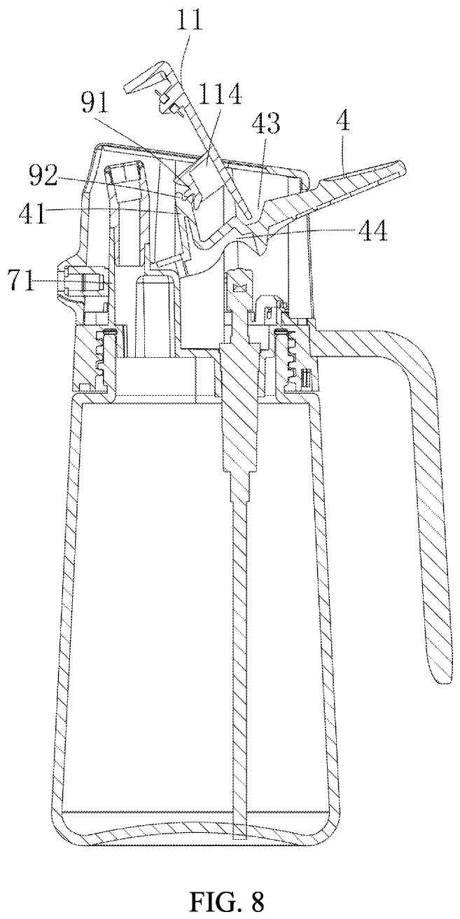

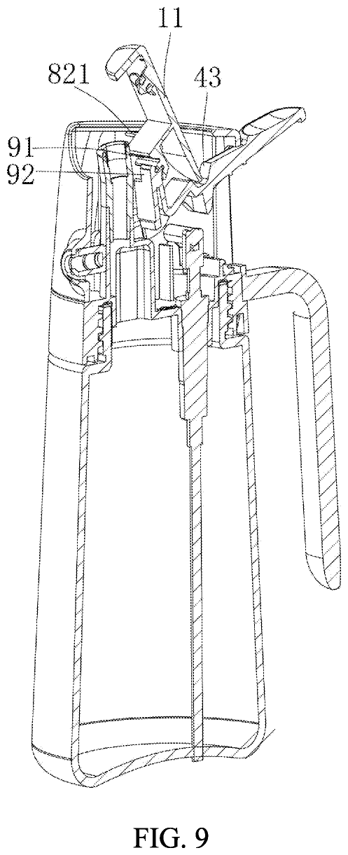

As shown in FIGS. 8 and 9, a relief groove 43 with an opening facing upward is formed in the actuator 4. When the cover plate 11 is driven to be opened, an end, away from the oil pouring spout 7, of the cover plate 11 enters the relief groove 43 to avoid interference with the actuator 4, such that the structure is more compact.

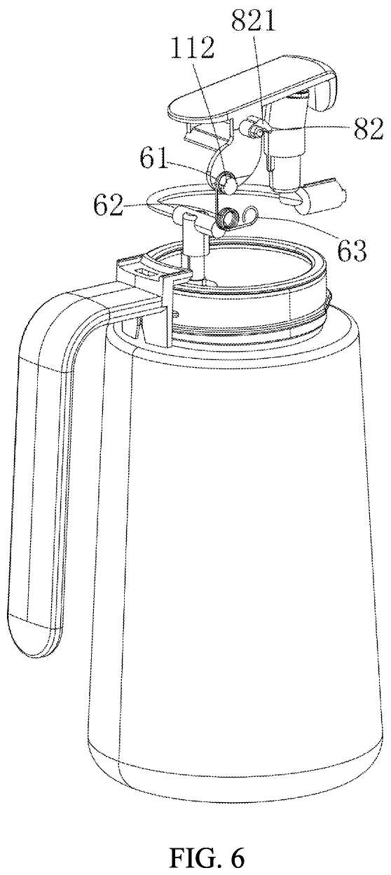

As shown in FIGS. 6 and 8, to limit the maximum opening angle of the cover plate 11, a limiting protrusion 821 is arranged on the second rotating shaft 82 of the cover plate 11. When the cover plate 11 is rotated to be opened, the limiting protrusion 821 rotates together with the second rotating shaft 82 until the limiting protrusion 821 abuts against an inner wall of the top of the hood 14, such that the cover plate 11 is prevented from further rotation.

In addition, the second dip tube 54 may be arranged on an outer side of the vertical plates 13 of the base 12, and extends in a circumferential direction of the base 12. In this way, the space may be fully used to make the internal structure of the lid 1 more compact and ordered.

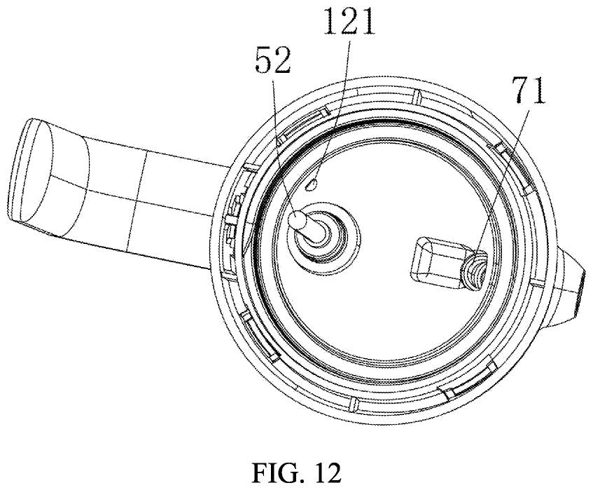

As shown in FIG. 12, a vent hole 121, extending through the base 12, is formed in a side, away from the oil pouring passage 71, of the base 12. The vent hole 121 may balance the air pressure in the bottle and the air pressure in the outside; and the vent hole 121 is away from the oil pouring passage 71, such that oil is prevented from flowing into the vent hole 121 when poured out of the bottle.

According to the oil dispenser provided by the embodiments of the present disclosure, the rotatable actuator 4 may be pressed to achieve the oil spraying function and may also be lifted to open the lid to achieve the oil pouring function. The operation logic is visual (the actuator is pressed to spray oil and is lifted to open the oil pouring spout), and users may switch the functions quickly with a single hand, thus improving the convenience of use. Moreover, such a design simplifies the internal control structure of the lid 1 and reduces the number of parts such as independent buttons, thereby reducing manufacturing costs and improving reliability.

What is claimed is:

1. An oil dispenser, comprising a lid and a bottle detachably fixed to the lid, wherein the lid is provided with:
an actuator, rotatably connected to the lid, partially uncovered by the lid to be operated, and partially extending into the lid;
an oil spraying member, arranged below the actuator and used for spraying oil;
an oil pouring spout, used for pouring oil and communicating an inside of the bottle with an outside;
a cover plate, rotatably connected to the lid and having a closed position for sealing the oil pouring spout;
an elastic element, arranged between the cover plate and the lid, and used for applying an elastic force to the cover plate to enable the cover plate to tend to the closed position; and
a link, arranged between the actuator and the cover plate;
wherein the actuator has a first operation state and a second operation state; in the first operation state, the actuator acts on the oil spraying member to spray oil; in the second operation state, the actuator acts on the cover plate by means of the link to enable the cover plate to open the oil pouring spout.

2. The oil dispenser according to claim 1, wherein the link comprises a first abutting portion arranged on the cover plate and a second abutting portion arranged on the actuator;
when pressed, the actuator enters the first operation state to press the oil spraying member to implement oil spraying;
when lifted, the actuator enters the second operation state, and the second abutting portion pushes against the first abutting portion to enable the cover plate to overcome the elastic force of the elastic element to rotate, so as to open the oil pouring spout.

3. The oil dispenser according to claim 1, wherein the elastic element comprises an elastic portion, as well as a first connection portion and a second connection portion which are connected to the elastic portion, the fist connection portion is connected to the cover plate, and the second connection portion is connected to the lid;
when the actuator is lifted and drives the cover plate to open the oil pouring spout, the first connection portion and the second connection portion move close to each other, such that the elastic portion generates an elastic force for driving the first connection portion and the second connection portion to move away from each other.

4. The oil dispenser according to claim 3, wherein the elastic element is a torsion spring;
the elastic portion is a spiral portion of the torsion spring and is in a free suspended state;
the first connection portion and the second connection portion are two spring legs of the torsion spring, respectively;
the cover plate is provided with a first pin around which the first connection portion is disposed, and the lid is provided with a second pin around which the second connection portion is disposed.

5. The oil dispenser according to claim 2, wherein the first abutting portion and the second abutting portion are both toothed; and when the actuator is lifted, the first abutting portion and the second abutting portion are engaged with each other.

6. The oil dispenser according to claim 1, wherein a first rotating shaft is arranged at an end, located inside the lid, of the actuator, and the lid is provided with a shaft hole rotatably connected to the first rotating shaft.

7. The oil dispenser according to claim 2, wherein the oil spraying member comprises a pump, an oil spraying spout, a first dip tube connected between the pump and the bottle, and a second dip tube connected between the pump and the oil spraying spout;
a matching socket with an opening facing downward is formed in a lower end of the actuator, and at least an upper portion of the pump is received in the matching socket;
in a natural state, the actuator is supported on the pump by means of a wall of the matching socket.

8. The oil dispenser according to claim 7, wherein the actuator is configured to press the pump downward by means of the wall of the matching socket when pressed, so as to enable the pump to pump oil.

9. The oil dispenser according to claim 7, wherein the lid comprises a hood and a base, two vertical plates extending upward are arranged on the base, the cover plate is located between the vertical plates and provided with a second rotating shaft, and the vertical plates are provided with shaft holes rotatably connected to the second rotating shaft.

10. The oil dispenser according to claim 9, wherein the second dip tube is located on an outer side of the vertical plates and extends in a circumferential direction of the base.

11. The oil dispenser according to claim 2, wherein a relief groove with an opening facing upward is formed in the actuator; and when the actuator is lifted and the cover plate opens the oil pouring spout, an end, away from the oil pouring spout, of the cover plate is located in the relief groove.

12. The oil dispenser according to claim 9, wherein a limiting protrusion is arranged on the second rotating shaft of the cover plate; an inner wall of a top of the hood of the lid corresponds to the limiting protrusion; and when the cover plate is rotated to be opened, the limiting protrusion rotates together with the second rotating shaft and abuts against the inner wall of the top of the hood to limit a maximum opening angle of the cover plate.

13. The oil dispenser according to claim 9, wherein an oil pouring passage is integrally formed in the base, an inlet end of the oil pouring passage communicates with the inside of the bottle, and the oil pouring spout is arranged at an outlet end of the oil pouring passage.

14. The oil dispenser according to claim 13, wherein an end, extending into the lid, of the actuator is U-shaped, and an open side of the U-shaped end faces the oil pouring passage, such that a clearance for receiving the oil pouring passage is formed between the actuator and the base.

15. The oil dispenser according to claim 1, wherein a plug is arranged on the cover plate, and with the rotation of the cover plate, the plug selectively seals the oil pouring spout.

16. The oil dispenser according to claim 2, wherein the cover plate is provided with a first link block extending towards the actuator, and the first abutting portion is arranged at an end of the first link block; and the actuator is provided with a second link block extending towards the cover plate, and the second abutting portion is arranged at an end of the second link block.

17. The oil dispenser according to claim 13, wherein a vent hole, extending through the base, is formed in a side, away from the oil pouring passage, of the base.
